(19) United States
(12) Patent Application Publication
(10) Pub. No.: US 2018/0085283 A1
(43) Pub. Date: Mar. 29, 2018

(54) SYSTEM AND METHOD FOR SENSORY OUTPUT DEVICE ATTACHMENT

(71) Applicant: NeoSensory, Inc. c/o TMCx+260, Houston, TX (US)

(72) Inventor: Syed Rahman, Houston, TX (US)

(21) Appl. No.: 15/716,195

(22) Filed: Sep. 26, 2017

Related U.S. Application Data
(60) Provisional application No. 62/399,840, filed on Sep. 26, 2016.

(51) Int. Cl. A61H 23/02; A41D 1/00

(52) U.S. Cl. CPC A61H 23/02; A41D 1/005; A61H 2201/5097; A61H 2201/5058; A61H 2201/5007; A61H 2201/165

(57) ABSTRACT

A system for stimulation of a user, including: a stimulation assembly including a sensory output device, a housing surrounding the stimulation assembly and defining a first coupling structure, and a retainer defining a second coupling structure; operable in a coupled mode wherein: second coupling structure encircles the first coupling structure, a region of a material is retained between the first and second coupling structures, and the material couples the housing to the user.

### CROSS-REFERENCE TO RELATED APPLICATIONS

This application claims the benefit of U.S. Provisional Application Ser. No. 62/399,840, filed on Sep. 26, 2016, which is incorporated in its entirety by this reference.

### TECHNICAL FIELD

This invention relates generally to the sensory output field, and more specifically to a new and useful system and method for sensory output device attachment.

### BRIEF DESCRIPTION OF THE FIGURES

FIG. 1 is an exploded view of a first example of the system.

FIG. 2 is an exploded view of a second example of the system.

FIG. 3 is a side view of the second example.

FIG. 4 is a first perspective view of the second example.

FIG. 5 is a second perspective view of the second example.

FIG. 6 is an exploded view of a third example of the system.

FIG. 7 is a perspective view of a fourth example of the system in an uncoupled configuration.

FIG. 8 is a perspective view of the fourth example of the system in an coupled configuration.

FIGS. 9A and 9B are schematic representations of an embodiment of the system in an uncoupled and coupled configuration, respectively.

FIG. 10 is a schematic representation of a variation of the system including an array of device assemblies.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System

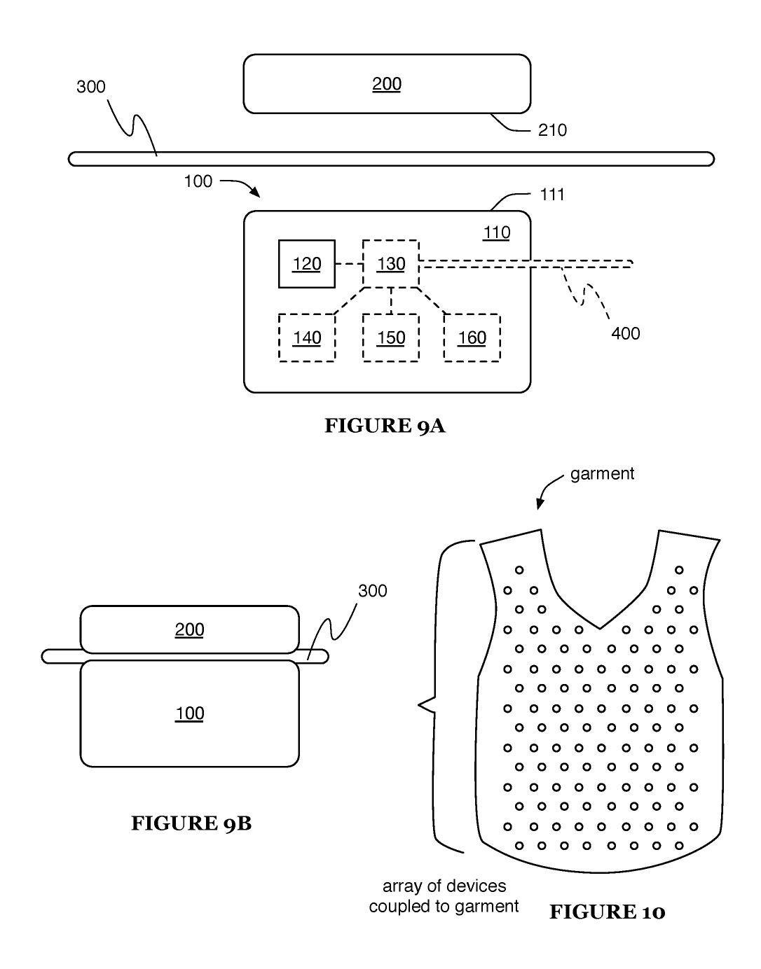

A system 10 for sensory output device attachment preferably includes a device assembly 100 and attachment substrate 300, and can additionally or alternatively include a retainer 200 and/or interconnect 400 (e.g., as shown in FIG. 9A). However, the system 10 can additionally or alternatively include any other suitable elements. The system 10 functions to attach the device assembly 100 to the attachment substrate 300, which can enable sensory output delivery by the device assembly 100.

### 1.1 Device Assembly

The device assembly 100 preferably includes a housing 110 and sensory output device 120, and can additionally or alternatively include a processing module 130, sensor 140, wireless communication module 150, power module 160, device substrate 170, and/or any other suitable elements.

The housing 110 preferably functions to house the device components (e.g., sensory output device 120, processing module 130, sensor 140, wireless communication module 150, power module 160, device substrate 170, etc.) and/or to couple the device assembly 100 to the attachment substrate 300. The housing 110 preferably defines a housing coupling structure 111 (e.g., as described below regarding the coupling mechanism), which can enable device assembly 100 coupling to the attachment substrate 300 and/or retainer 200.

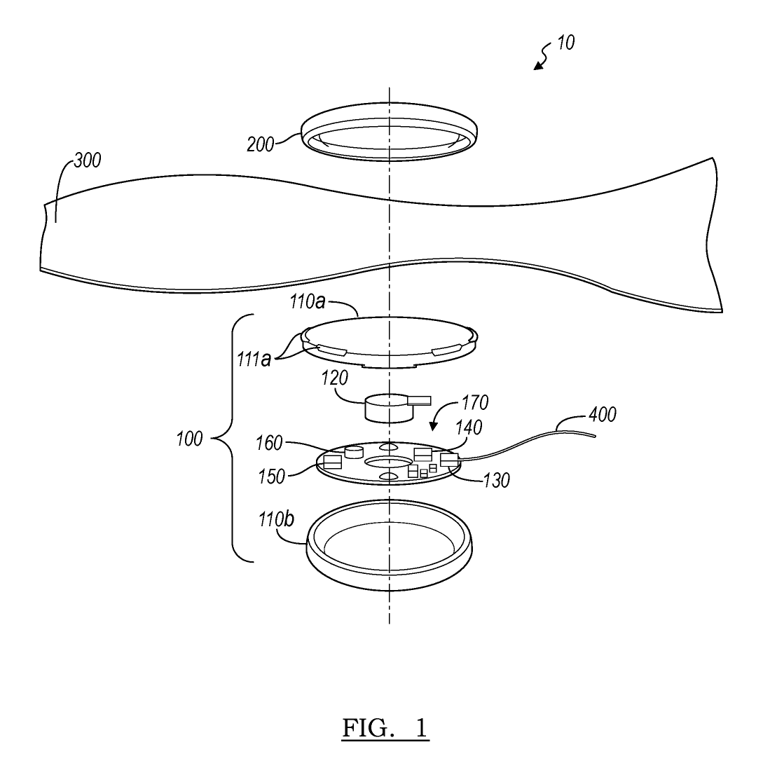

The housing 110 can include a single part (e.g., can be of unitary construction) or multiple parts (e.g., first part 110a and second part 110b, such as shown in FIG. 1). The housing 110 can optionally include one or more apertures (e.g., between the housing exterior and the ambient environment). The apertures can be defined at the intersection of the housing parts (e.g., wherein multiple intersecting parts define voids such as slots, which cooperatively define the aperture; wherein a first part defines a void that, with a flat surface of a second part, cooperatively defines the aperture; etc.), within a single housing part, and/or in any other suitable location(s). One or more interconnects 400 such as conductive leads 410 preferably extend through the apertures (e.g., enabling electrical access to components within the housing 110). However, the apertures can additionally or alternatively allow egress of any other suitable elements of the system, provide ventilation and/or drainage, and/or have any other suitable function.

The housing 110 preferably prevents ingress of water and/or other fluids (e.g., fluidly isolates device components within the housing from the ambient environment surrounding the housing, hermetically seals the housing interior, prevents liquid ingress into the housing interior, etc.). In embodiments that include a housing aperture, the aperture can be sealed by the interconnect 400 (and/or other element) extending through it, cooperatively sealed by the interconnect 400 and a sealant such as a silicone material, sealed in any other suitable manner, and/or be unsealed. The housing 110 can optionally be configured to withstand washing, such as in a garment washing machine (e.g., configured to withstand submersion in soapy water, mechanical agitation, etc.). In embodiments with multiple housing parts, the multiple parts of the housing are preferably joined by ultrasonically welding, overmolding, or using another suitable attachment process, or any combination thereof, and/or joined around one or more seals (e.g., compressive seals) such as gaskets (e.g., elastomeric gasket retained between and compressed by two housing parts), in a manner that provides a seal (e.g., waterproof seal to prevent moisture, water, and other liquids from penetrating the enclosure and coming into contact with components within the housing, hermetic seal, etc.). However, the parts can additionally or alternatively be joined using any other suitable process(es), including processes that may not seal the housing, and/or can be separate, and the housing 110 can alternatively not define a waterproof interior.

The housing 110 (e.g., any or all of the housing parts) can include (e.g., be made of) aluminum, copper, stainless steel, another suitable metal or metal alloy, a suitable inorganic compound, a suitably rigid and suitably malleable plastic or other suitable synthetic polymer, any other suitable material, and/or any other suitable combination thereof. The housing 110 (e.g., any or all of the housing parts) can have a translucency anywhere within a range from transparent to opaque.

The device assembly 100 preferably includes one or more sensory output devices 120, such as tactile interface devices (e.g., haptic actuators, electrical stimulators, etc.), but can additionally or alternatively include sensor inputs or any other suitable system. The system can provide haptic stimuli (e.g., vibrations, pulsations, exerted pressures, etc.) through the tactile interface devices. The tactile interface devices can include eccentric rotating mass (ERM) devices, Linear Resonant Actuators (LRAs), piezoelectric devices, and/or any other suitable devices (and/or combinations thereof, such as hybrid devices incorporating both ERM and LRA elements). The sensory output devices can additionally or alternatively provide one or more of: auditory stimuli, electrical stimuli (e.g., peripheral stimuli, etc.), olfactory stimuli, taste stimuli, thermal stimuli (e.g., heat- and/or cold-generating devices), and any other suitable form of stimulus.

In some embodiments, the sensory output device 120 is cooperatively formed by the device assembly 100 and the retainer 200 (e.g., wherein the device assembly 100 and retainer 200 cooperatively form an LRA). For example (e.g., in embodiments in which the device assembly 100 and retainer 200 are magnetically coupled), one or both can include an electromagnet which can be controlled to alter a magnetic coupling force between magnetic elements (e.g., electromagnets, permanent magnets, etc.) of the device assembly 100 and retainer 200, thereby causing motion of the system 10 and/or its components.

The sensory output device 120 can be configured to be controlled and/or powered by (e.g., electrically coupled to) the processing module 130, the power module 160, an external device (e.g., via the interconnect 400), and/or any other suitable elements. However, the sensory output device 120 can be configured in any other suitable manner, and/or the device assembly 100 (and/or any other suitable element of the system 10) can additionally or alternatively include any other suitable actuators and/or other output devices.

The processing module 130 preferably functions to receive input information (e.g., from the device components such as the sensor 14o, power module 160, and/or sensory output device 120; from one or more external devices, such as via the interconnect 400 and/or wireless communication module 150; etc.) and/or control device component operation (e.g., sensory output device 120 actuation, sensor 140 operation, etc.).

The processing module 130 can include one or more processors (e.g., CPU or other microprocessor, embedded controller, control circuit, relay system, etc.), computer memory modules (e.g., RAM), computer storage modules (e.g., hard disk drive, flash memory, etc.), and/or any other suitable elements.

The processing module 130 is preferably configured to control and/or receive information from the outputs, inputs, communication modules, power modules, and/or any other suitable elements of the system. For example, the processing module 130 can be configured to receive power and/or data via the interconnect 400, receive power from the power module 160, receive input information from the sensor 140 and/or wireless communication module 150, control power distribution to the device components, control sensory output device 120 operation (e.g., based on the input information), and/or perform any other suitable processing tasks.

The processing module 130 can be configured to selectively provide power (e.g., from the power module 160, from the interconnect 400, etc.) to each sensory output device 120 (e.g., by regulating the current provided to each sensory output device 120) or to selectively command each sensory output device 120 to enter a mode or attain a setpoint parameter value (e.g., by communicating a command to an integrated controller of each sensory output device 120). However, the processing module can additionally or alternatively be configured to control the sensory output devices 120 in any other suitable manner, or can be configured to not control the sensory output devices 120.

The sensor(s) 140 preferably include microphones and/or other audio sensors, but can additionally or alternatively include sensors associated with other sensory experiences (e.g., visual, tactile, olfactory, taste, etc.), other environmental information (e.g., location, location type, velocity, temperature, humidity, etc.), and/or any other suitable information. For example, the sensors 140 can include one or more: cameras (e.g., CCD, CMOS, multispectral, visual range, hyperspectral, stereoscopic, etc.), spatial sensors (e.g., inertial measurement sensors, accelerometer, gyroscope, altimeter, magnetometer, etc.), location sensors (e.g., GPS, GNSS, triangulation, trilateration, etc.), audio sensors (e.g., transducer, microphone, etc.), barometers, light sensors, temperature sensors, current sensor (e.g., Hall effect sensor), air flow meter, voltmeters, touch sensors (e.g., resistive, capacitive, etc.), proximity sensors, force sensors (e.g., strain gauge meter, load cell), vibration sensors, chemical sensors (e.g., for detecting ambient levels of various chemical substances), sonar sensors, environmental sensors for measuring or monitoring environmental parameters (e.g., temperature, humidity, audible noise levels, visible sunlight, velocity, acceleration, etc.), and/or health sensors (e.g., for monitoring physiological parameters such as heart rate, skin temperature, etc.). However, the system can additionally or alternatively include any other suitable sensors (and/or other sources of input information).

The wireless communication module 150 (e.g., radio) preferably supports (e.g., enables communication using) one or more wireless communication protocols (e.g., WiFi, Bluetooth, BLE, NFC, RF, IR, Zigbee, Z-wave, etc.). For example, the wireless communication module 150 can include digital signal processors, wireless transceivers, antennas, and other components for providing a radio frequency (RF) module suitable for wirelessly communicating with another device using a cellular communication protocol, WiFi or one or more other suitable public or private local area wireless protocols, Bluetooth or one or more other suitable public or private personal area network protocols. However, the system can additionally or alternatively include any other suitable communication modules.

The power module 160 preferably includes a battery, more preferably a secondary battery but alternatively a primary battery, but can additionally or alternatively include a capacitor (e.g., to facilitate fast discharging in combination with a battery), a fuel cell with a fuel source (e.g., metal hydride), a thermal energy converter (e.g., thermionic converter, thermoelectric converter, mechanical heat engine, etc.) optionally with a heat source (e.g., radioactive material, fuel and burner, etc.), a mechanical energy converter (e.g., vibrational energy harvester), a solar energy converter, and/or any other suitable power source. The secondary battery can have a lithium phosphate chemistry, lithium ion polymer chemistry, lithium ion chemistry, nickel metal hydride chemistry, lead acid chemistry, nickel cadmium chemistry, metal hydride chemistry, nickel manganese cobalt chemistry, magnesium chemistry, or any other suitable chemistry. The primary battery can have a lithium thionyl chloride chemistry, zinc-carbon chemistry, zinc chloride chemistry, alkaline chemistry, oxy nickel hydroxide chemistry, lithium-iron disulfide chemistry, lithium-manganese oxide chemistry, zinc-air chemistry, silver oxide chemistry, or any other suitable chemistry.

The power module 160 can additionally or alternatively include a wireless power receiver (e.g., inductor for inductive power reception). The wireless power receiver can be configured to charge the battery, to power the device components directly (e.g., in a device assembly 100 without a battery; when a battery is present, in addition to or in place of charging the battery; etc.), and/or be configured in any other suitable manner.

The power module 160 is preferably electrically coupled (e.g., connected by conductive wires) to the powered device components (e.g., sensory output device 120, processing module 130, sensor 140, wireless communication module 150, etc.), wherein the processing module 130 preferably controls power provision (e.g., as described above), but power provision and/or battery management can additionally or alternatively be performed by any other suitable components.

One or more device components can be arranged on and/or around (e.g., attached to, retained against, etc.) one or more component substrates 170. The component substrate 170 preferably includes (e.g., is made of) one or more layers of glass epoxy material and/or another suitable electrically non-conductive material. One or more interconnects or traces of copper, gold, or other electrically conductive element, an alloy thereof, or other electrically conductive compound may be etched into or otherwise impressed upon or affixed to the component substrate 170 as needed (e.g., forming a printed circuit board).

The system 10 can optionally include additional components (e.g., attached to the component substrate 170), which may include passive components, including resistors, capacitors, and so forth, and active components, including integrated circuits, transistors, diodes, switches, operational amplifiers, and so forth. Diode components may include light emitting diode components, configured to produce light of one or more colors. Depending upon the placement of light emitting diodes (e.g., on the component substrate 170), and/or upon translucency of materials used for the housing 110 and/or component substrate 170, any such light may be externally visible.

In some embodiments, the component substrate 170 defines an aperture (e.g., circular aperture) or multiple apertures, sized and shaped to receive a sensory output device 120, which may be in electrical contact with or otherwise electrically coupled to the component substrate 170. The sensory output device 120 may provide a switch or other suitable means for initiating and/or terminating a process or function performed by or supported by the device components.

In some embodiments, the component substrate 170 can be integrated with the housing 110 (e.g., formed on an interior housing wall) and/or other device components. The functionality associated with the device components can additionally or alternatively be integrated within the sensory output device 120 and/or other device components (e.g., thereby enabling omission of the component substrate).

### 1.2 Retainer

The retainer 200 preferably defines a retainer coupling structure 210 (e.g., as described below regarding the coupling mechanism), which can function to couple the device assembly 100 to the attachment substrate 300. The retainer coupling structure 210 and housing coupling structure 111 are preferably complementary (e.g., configured to couple to each other), but can additionally or alternatively have any other suitable conformation(s).

The retainer 200 can define a cap, ring, plug, and/or any other suitable structures. The retainer 200 can include (e.g., be made of) aluminum, copper, stainless steel, another suitable metal or metal alloy, a suitable inorganic compound, a suitably rigid and suitably malleable plastic or other suitable synthetic polymer, any other suitable material, and/or any other suitable combination thereof. The retainer 200 can have a translucency anywhere within a range from transparent to opaque. The retainer 200 can include the same material(s) as the housing 110 (e.g., have the same composition, include the same materials in different mixtures, etc.) and/or different material(s).

The retainer 200 can optionally include any or all device components described above (e.g., instead of or in addition to such components being included in the device assembly 100), such as the sensory output device 120, processing module 130, sensor 140, wireless communication module 150, power module 160, and/or device substrate 170.

### 1.3 Attachment Substrate

The attachment substrate 300 preferably functions to couple the system 10 to a user, but can additionally or alternatively couple the system 10 to any other suitable elements (e.g., to a vehicle, such as wherein the attachment substrate 300 is the fabric of a car seat; to a table, such as wherein the attachment substrate 300 is a tablecloth; etc.) and/or can perform any other suitable function. The attachment substrate 300 is preferably a flexible substrate (e.g., preferably conforms to the housing and/or retainer coupling structures). For example, the attachment substrate 300 can be a textile and/or other fabric.

The attachment substrate 300 is preferably a wearable garment (or portion of a garment), such as a top (e.g., shirt, vest, etc.), a bottom (e.g., pants, shorts, skirt, etc.), a headpiece (e.g., headband, earmuffs, hat, etc.), a backpack, an undergarment, socks, or any other suitable form of garment (e.g., wherein the system 10 is coupled to the user when the garment is worn by the user). In some such embodiments, the housing 110 (e.g., housing piece 110b, such as shown in FIG. 5) may be in contact with or in close proximity to the user (e.g., retained in contact with the user's skin by the garment). If less contact between the device assembly 100 and the user is desirable, a concave housing piece (e.g., defining an external convexity) may be desired, whereas if more contact between user and device is desirable, a planar housing piece may be desired.

However, the attachment substrate 300 can additionally or alternatively include a rigid substrate and/or any other suitable elements.

### 1.4 Coupling Mechanism

The system 10 is preferably operable between a coupled mode, wherein the device assembly 100 is coupled to (e.g., retained against) the attachment substrate 300, and an uncoupled mode, wherein the device 100 is uncoupled from the attachment substrate 300. The device assembly 100 and attachment substrate 300 are preferably coupled such that the device assembly 100 can transmit sensory outputs (e.g., tactile outputs such as vibrations) to the user (e.g., user to which the attachment substrate 300 is coupled, such as user wearing the garment).

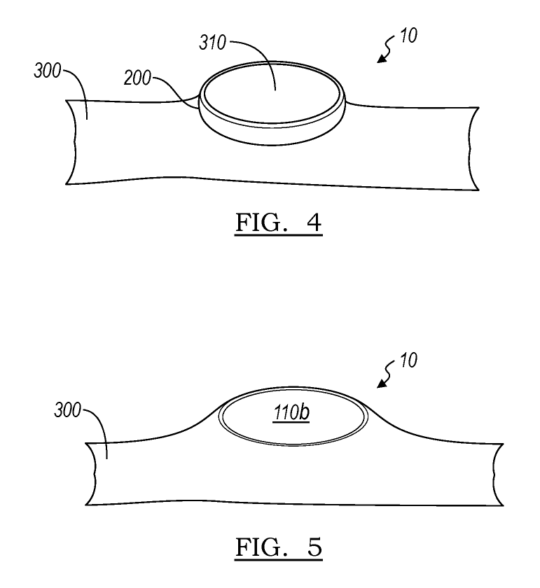

In embodiments that include a retainer 200, the device assembly 100 is coupled to the attachment substrate 300 by the retainer 200 (e.g., in a ‘snap-fit’ coupling between the device assembly 100 and retainer 200). The housing 110 and retainer 200 preferably cooperatively form a snap-fit assembly (e.g., an annular, torsional, or cantilevered snap-fit), but alternatively be magnetic, adhesive, use Van der Waals forces, or cooperatively form or use any other suitable retention mechanism. The attachment substrate 300 is preferably retained between the housing 110 and the retainer 200 (e.g., between the housing coupling structure in and retainer coupling structure 210), such as by a retention force (e.g., compressive force) exerted on the attachment substrate 300 by the coupling structures. The attachment substrate 300 can be encircled by one coupling structure (e.g., while partially or entirely encircling the other coupling structure, such as shown in FIGS. 3, 4, and 8), ‘sandwiched’ between the coupling structures (e.g., substantially planar coupling structures, such as shown in FIG. 9B), and/or have any other suitable arrangement with respect to the coupling structures.

The housing coupling structure in and retainer coupling structure 210 preferably exhibit a tight fit (e.g., interference fit, fit causing deformation of the housing 110 and/or retainer 200, etc.; with and/or without the attachment substrate 300 between the coupling structures). The cooperatively generated coupling force can be less than 1N, 1-2N (e.g., 1N, 1.5N, 2N, etc.), greater than 2N, or be any suitable force or range of forces. For example, in embodiments in which one coupling structure encircles the other, the encircling structure can define an opening size (e.g., inner diameter; opening width, such as for a square, rectangular, hexagonal, or otherwise non-circular coupling structure; etc.) and the encircled structure can define an outer size (e.g., outer diameter; outer width, such as for a square, rectangular, hexagonal, or otherwise non-circular coupling structure; etc.). In specific examples, the inner diameter (e.g., when uncoupled from the encircled structure, when coupled, etc.) can be: less than the outer diameter, less than the outer diameter plus the substrate thickness (or twice the substrate thickness), equal to the outer diameter or outer diameter and substrate thickness, or have any other suitable size.

The coupling preferably results in friction that resists movement of the attachment substrate 300 with respect to the coupling structures. The attachment substrate 300 is preferably deformed (with respect to its uncoupled shape) when in the coupled mode. For example, the attachment substrate 300 can be retained within a non-flat or circuitous space between the coupling structures, which can enhance substrate retention (e.g., by increasing the difficulty of moving the coupling structures with respect to the attachment substrate 300). To enhance attachment substrate 300 retention (e.g., enhance friction and/or adhesion, increase substrate deformation, etc.), the coupling structures and/or attachment substrate 300 can include materials (e.g., tacky material, adhesive material, high-friction material, etc.), surface treatments (e.g., roughness), topographical features (e.g., bumps, ridges, waves, etc.; preferably defined in a complementary manner on the coupling structures, such that they fit together, but additionally or alternatively defined in any other suitable manner), and/or any other suitable features.

The retainer 200 and housing 110 are preferably operable between a coupled and uncoupled mode, wherein the retainer 200 is coupled to the housing 110 by the coupling mechanism in the coupled mode and uncoupled from the housing 110 in the uncoupled mode. However, the retainer 200 and housing 110 can be operable in any other suitable set of modes. The retainer 200 preferably retains the sensory output device 120 along the interior surface of the attachment substrate 300 (e.g., proximal the user), but can alternatively retain the sensory output device along the exterior surface of the attachment substrate. The retainer 200 is preferably coupled offset from a housing center (e.g., a lateral housing plane, the housing center axis, etc.), but can alternatively be coupled along the housing center or along any suitable portion of the housing. The retainer preferably couples to the housing 110 proximal a first broad face of the housing 110, more preferably along a distal broad face (e.g., broad face furthest from the user), but can alternatively be coupled to a proximal broad face (e.g., broad face closest to the user) or to any other suitable surface.

The housing 110 and/or retainer 200 can optionally define one or more voids (e.g., through-holes, slots, openings, etc.) through which a portion (“exposed portion 310”) of the attachment substrate 300 can be exposed (e.g., as shown in FIGS. 3, 4, and 8). The exposed region 310 is preferably a region (e.g., contiguous region) bordered by one or more coupling structures, and can be retained against the housing 110 and/or retainer 200 (e.g., a hole in the retainer 200 can expose an exposed region 310 that is bordered by the retainer coupling structure 210 and retained against the housing no). The exposed region 310 may be greater than a threshold fraction of the amount (e.g., area, volume, etc.) of all attachment substrate 300 within a coupling region (e.g., envelope or convex hull of one or more coupling structures and/or attachment substrate regions, such as the region retained between the coupling structures) or of all attachment substrate 300 retained by the coupling structures. In some examples (e.g., in which the coupling region is the convex hull of the attachment substrate region retained between coupling structures), the threshold fraction can be 5%, 10%, 20%, 30%, 40%, 50%, 60%, 70%, 80%, 90%, 95%, 98%, and/or any other suitable value. However, any other suitable regions (or no regions) of any other suitable size can additionally or alternatively be exposed by the housing 110 and/or retainer 200.

In some embodiments, the system 10 is operable in an uncoupled mode after entering the coupled mode. The system 10 can be operable to repeatedly transition between the coupled and uncoupled modes, transition only once or a limited number of times, transition at a limited rate, and/or the transitions can be limited in any other suitable way. In the uncoupled mode, the device assembly 100 is preferably not retained against the attachment substrate 300 (e.g., the substrate 300 is not retained between the coupling structures) and the attachment substrate 300 preferably does not mechanically couple the device assembly 100 to the user (e.g., does not retain the device assembly 100 against or near the user). For embodiments that enable repeated coupling and uncoupling, the device assembly 100 is preferably operable to attach to different (e.g., arbitrary) locations on the attachment substrate 300, but can alternatively be restricted to returning to substantially the same position (or set of allowed positions) on the attachment substrate 300.

In one example, the retainer 200 is an elastomeric ring configured to tightly encircle the housing coupling structure 111. In this example, the ring can be repeatedly stretched to transition between the coupled and uncoupled modes (e.g., to fit around a retaining feature of the housing coupling structure), and released in order to maintain it in either mode (e.g., maintained in the coupled mode by its tight fit around the housing 110). However, the system 10 can be coupled and/or uncoupled in any other suitable manner.

The housing 110 and retainer 200 are preferably maintained in the coupled mode by a mechanical coupling mechanism. The coupling structures preferably include complementary features that mechanically couple them, more preferably retaining the attachment substrate 300 between them. However, the coupling structures can otherwise couple the housing 110 and retainer 200 together. In a first variation, the complementary features include ridges and complementary grooves. For example, one coupling structure can include one or more ridges such as circumferential ridges (e.g., fully encircling the structure; segmented, such as shown in FIGS. 1, 2, and 6; etc.) and the other coupling structure can include one or more grooves (e.g., fully encircling the structure, segmented in a complementary manner to the segmented ridges, etc.) into which the ridges fit and are retained. In a second variation, the complementary features include one or more voids (e.g., pockets) and complementary protrusions (e.g., fitting tightly in the pockets, such as having an interference fit). For example, the coupling structures can each define crenellated features, in which the merlons of one coupling structure fit (e.g., tightly, such as an interference fit) within the crenels of the other (e.g., with the attachment substrate 300 retained between them, within some or all of the crenels). In a third variation, the complementary features include a plug and a hole into which it fits. In a fourth variation, the complementary features include a tongue-and-groove system. However, any suitable set of features can be used.

The coupling mechanism can optionally include keying or alignment features. The alignment features can be axial, radial, or align the housing 110 and retainer 200 along any suitable axis. In one variation, the annular configuration of the coupling structures also function as the alignment feature. In a second variation, the coupling structures include radial fins that align with radial grooves in the complementary piece. In a third variation, the alignment features include complementary threading. However, any other suitable alignment features can be used.

In some embodiments (e.g., mechanically-coupled embodiments), one coupling structure preferably encircles the other. In a first variation, in which the retainer coupling structure 210 encircles the housing coupling structure in, the housing 110 and/or attachment substrate 300 can exert an outward force on the retainer 200, resulting in a tensile stress and/or strain in the retainer 200 (e.g., directed circumferentially around the retainer 200, directed around a perimeter of the retainer 200, etc.). In a second variation, in which the housing coupling structure in encircles the retainer coupling structure 210 (e.g., the retainer 200 includes a plug structure retained within a hole, such as a pocket or through-hole, of the housing 110), the retainer 200 and/or attachment substrate 300 can exert an outward force on the housing 110, resulting in a tensile stress and/or strain in the housing 110 (e.g., directed circumferentially around the hole of the housing 110, directed around a perimeter of the hole, etc.). However, the coupling structures can additionally or alternatively be mechanically coupled in any other suitable manner, and/or can exert any other suitable forces on each other, the attachment substrate 300, and/or any other suitable elements.

In some embodiments, coupling and/or uncoupling may be aided by thermal expansion and/or contraction of one or both coupling structures. For example (e.g., in an embodiment in which the retainer 200 encircles the housing 110 when coupled), the retainer 200 may be heated to a temperature sufficient to produce thermal expansion. The thermally expanded retainer 200 may then be attached to the housing 110. As the retainer 200 cools (thereby contracting), the strength and stability of the coupling between the retainer 200 and housing 110 can increase. Heat-assisted coupling, as well as other coupling techniques, may be used in embodiments referred to herein as permanent or dedicated embodiments, in which the device assembly 100 is attached to the attachment substrate 300 in a manner that is permanent or substantially permanent (e.g., cannot be readily detached without damaging the device). Such heat-assisted techniques (and/or other techniques) can additionally or alternatively be employed to assist in decoupling of the coupling structures (e.g., heating the retainer 200 to cause thermal expansion, thereby reducing the coupling force between the retainer 200 and housing 110 and/or allowing the retainer 200 to fit around a retaining feature of the housing coupling structure).

Some mechanically-coupled embodiments may require considerable force to effect the coupling (e.g., to allow single direction joining) and, in these embodiments, coupling may create a semi-permanent or permanent fit (e.g., cannot be readily detached without damaging the device). Such a fit can yield a durable construction that can withstand extensive use, while potentially allowing for quick, clean disassembly when service is necessary. As such, the aid of a tool for coupling and/or uncoupling the elements, such as a hammer, press, or snap fastener pliers, may be useful.

The housing 110 and retainer 200 can additionally or alternatively be maintained in the coupled mode by a magnetic coupling mechanism (e.g., wherein each coupling structure includes one or more magnetic elements, such as permanent magnets and/or electromagnets, which attract each other, thereby coupling the housing 110 and retainer 200 and preferably retaining the substrate between them) and/or any other suitable coupling mechanism.

The housing 110 and retainer 200 preferably do not penetrate the attachment substrate 300 (e.g., the housing 110 and retainer 200 are separated entirely by the substrate), and the attachment substrate 300 (or a region thereof, such as the region retained by the coupling structures) is preferably continuous (e.g., does not include ruptures, tears, or holes). Alternatively, the attachment substrate 300 can be penetrated by one or more elements of the housing 110 and/or retainer 200, which are held captive within the penetration hole(s).

The device assembly 100 and attachment substrate 300 can additionally or alternatively be coupled in any other suitable manner. In some examples, the coupling can rely in part or whole on adhesives (e.g., adhering the housing 110 to the attachment substrate 300), ruptures or holes in the attachment substrate 300 (e.g., penetrated by an element of the housing 110 and/or retainer 200, as described above), sewing (e.g., thereby affixing the housing 110 in place), and/or excess fabric or material (e.g., retaining the housing 110 within a pocket).

### 1.5 Interconnect

The system 10 can optionally include one or more interconnects 400 (e.g., electrical and/or electronic interconnects). The interconnect 400 preferably functions to provide power and/or control signals (e.g., from one or more external devices, such as a power supply, controller, etc.) to the device assembly 100 (e.g., to components enclosed within the housing 110). The interconnect 400 preferably supplies electrical power and/or data encoded in electrical and/or electronic signals (e.g., enabling wired data connections such as USB, Ethernet, I2C, SPI, etc.), but can additionally or alternatively include non-electrically conductive data connections (e.g., optical fiber connections) and/or any other suitable connections.

The interconnects 400 can include one or more conductive leads 410 (e.g., electrically conductive solid or stranded wires of copper or another suitable conductive element or compound), electrical feedthroughs 420 (e.g., conductive material forming a portion of the housing, thereby providing a conductive path between the housing interior and exterior), substrate-embedded conductors 430 (e.g., conductors embedded in or otherwise retained on an attachment substrate 300, such as conductive materials woven into a fabric substrate 300), and/or any other suitable electrical connectors.

The substrate-embedded conductors 430 preferably define conductive paths (e.g., form conductive leads), but can additionally or alternatively have any other suitable shape. The substrate-embedded conductors 430 can include contacts 431 (e.g., terminals, conductive pads, etc.) enabling electrical contact to the conductors 430, and/or can enable electrical contact throughout their length. The substrate-embedded conductors 430 and/or their contacts 431 can be defined at specific locations in the attachment substrate 300 (e.g., device-attachment locations), and/or can enable electrical contact with more arbitrary device placement (e.g., can form an array of conductors, such as a linear array).

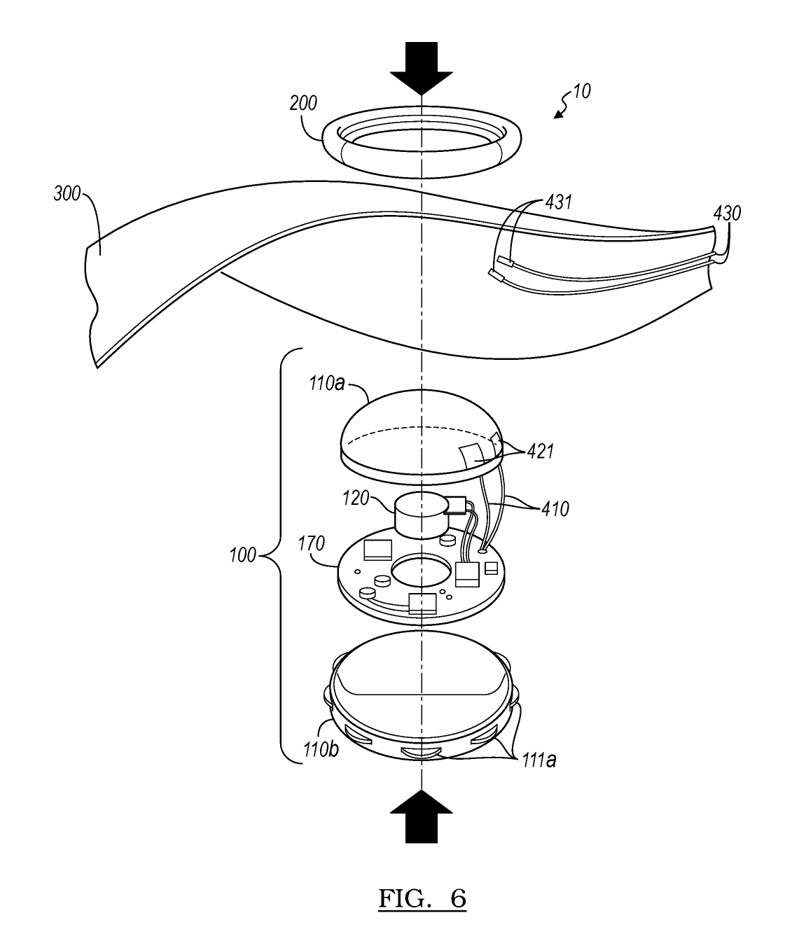

In some embodiments, a conductive lead 410 (or multiple leads) are connected (and/or otherwise electrically coupled) to one or more components within the housing 110 (e.g., sensory output device 120, processing module 130, power module 160, etc.), and extend through an aperture of the housing 110 (e.g., as shown in FIGS. 1, 2, and 9A), thereby enabling electrical coupling of the connected components to an external device. In other embodiments, conductive leads 410 connect one or more components within the housing 110 (e.g., sensory output device 120, processing module 130, power module 160, etc.) to an interior side of electrical feedthroughs 420. In some such embodiments, the feedthroughs 420 includes contacts 421 (e.g., conductive pads) on the exterior side that can connect (e.g., in the coupled mode) to contacts 431 of substrate-embedded conductors 430 (e.g., as shown in FIG. 6) and/or to any other suitable conductors. In other embodiments, conductive leads 410 and/or substrate-embedded conductors 430 define inductive power transmitters (e.g., conductive loops, coils, etc.), which can enable inductive power transfer to inductive power receivers (e.g., conductive loops, coils, etc.) of the device assembly 100 (e.g., a receiver within the housing 110). However, the system 10 can additionally or alternatively include any other suitable interconnects 400, in any other suitable arrangement, with any other suitable electrical connectivity.

### 1.6 Device Arrangements

The system 10 can optionally include a plurality of device assemblies 100 (e.g., including tactile interface devices such as haptic actuators and/or electrical stimulators) in a spatial distribution (e.g., multidimensional spatial distribution), each of which has a range of available output stimuli with different stimulus parameters (e.g., as shown in FIG. 10. The spatial distribution (e.g., array) of device assemblies 100 can have a density from 5 devices per cm² to 50 devices per cm², or any other suitable density. Furthermore, the spatial distribution of device assemblies 100 can be configured with any suitable morphological aspects. The device assemblies 100 are preferably arranged in one or more arrays, preferably high-density arrays but additionally or alternatively arrays of any suitable density. The arrays can include multidimensional arrays (e.g., planar array, 3-dimensional volumetric array, array defined substantially along one or more device surfaces, etc.), single-dimensional arrays (e.g., linear array, curvilinear array, etc.), and/or any other suitable arrays. For example, the device can include a two-dimensional array (e.g., defined substantially on a plane, defined on a curved and/or bent surface, etc.). The arrays can be configured as one or more of: a circular array, an ellipsoidal array, a polygonal array (e.g., a triangular array, rectangular array, a pentagonal array, a hexagonal array, etc.), a circumscribing array, an amorphous array, an array substantially spanning the attachment substrate 300, and any other suitable array type. Additionally or alternatively, the system 10 can include an irregular distribution of device assemblies 100 (e.g., arranged on the attachment substrate 300) and/or any other suitable arrangement of device assemblies 100. Furthermore, the spatial distribution (e.g., array) can be configured across different layers of the overarching system coupled to the user (e.g., different attachment substrates 300, different layers of an attachment substrate 300, etc.).

In one embodiment, the system 10 includes a system-wide computing module (e.g., including a processor and/or a radio, such as described above regarding the processing module 130 and wireless communication module 150 or otherwise), a power module 160, and a plurality (e.g., array) of device assemblies 100 configured to be controlled by the system-wide computing module, all attached to an attachment substrate 300 (e.g., wearable garment such as a vest). In this embodiment, each device assembly 100 includes one or more sensory output devices 120 (e.g., a haptic stimulation unit such as an LRA and an optical output device such as an LED), and can optionally include a controller (e.g., processing module 130) configured to control the sensory output devices. Each device assembly 100 is preferably electrically coupled to the system-wide computing module and/or power module 160 (e.g., by a control wire, power wire, and ground wire), but can additionally or alternatively be connected in any other suitable manner. In a first example of this embodiment, the system 10 additionally includes one or more sensors 140 (e.g., attached to the attachment substrate 300) such as microphones. In a second example, the system 10 is configured to communicate (e.g., wirelessly, such as using the radio) with one or more external sensors, such as a microphone of a user device (e.g., smart phone transmitting microphone data to the system 10 using a wireless protocol such as Wi-Fi or Bluetooth).

However, the system 10 can include any other suitable arrangement of device assemblies 100, or can alternatively include only a single device assembly 100.

### 1.7 Example Embodiments

In a first embodiment of the system 10 (e.g., as shown in FIG. 1), the retainer 200 includes a cap with a lip (e.g., defining a void within the cap) which can (e.g., in the coupled mode) retain the ridges 111a protruding from the first housing part 110a. The cap is configured to ‘snap-attach’ to the housing 110, with the cap on a first side of the attachment substrate 300 (e.g., textile fabric of a wearable garment) and the housing 110 on the other side, thereby locking the attachment substrate 300 between the cap and the housing 110. In some variations of this embodiment, the housing 110 (e.g., formed by the first housing part 110a and second housing part 110b) encloses a component substrate 170, a number of components (e.g., processing module 130, sensor 140, wireless communication module 150, power module 160) attached to the component substrate 170, and one or more sensory output devices 120 (e.g., vibratory actuator and LED) electrically coupled to and arranged within an aperture of the component substrate 170. In some variations, an interconnect 400 (e.g., including one or more conductive leads 410) is connected to the processing module 130 and extends through an aperture of the housing 110 (e.g., an aperture cooperatively defined by the first and second housing parts), enabling connection of the processing module 130 to an external device.

Although the system 10 illustrated in FIG. 1 includes a dome-shaped or concave retainer 200, a planar first housing part 110a, and a concave second housing part 110b, the particular curvature of these elements is an implementation detail that may vary depending upon the application and other factors. For example, the retainer 200 and/or second housing part 110b may define a shallow cylinder that includes a planar surface (instead of concave surfaces). A height or depth of such a cylinder may be greater than, less than, or approximately equal to a maximum height or depth of the concave retainer 200 and second housing part 110b illustrated in FIG. 1. Thus, the system 10 may have two concave surfaces, two planar surfaces, or one concave surface and one planar surface. In still other embodiments, the retainer 200 and/or second housing part 110b may have a complex surface curvature that is neither entirely planar or entirely concave. In any such other embodiments, the complex surface curvature may provide functional features, ornamental features, or both.

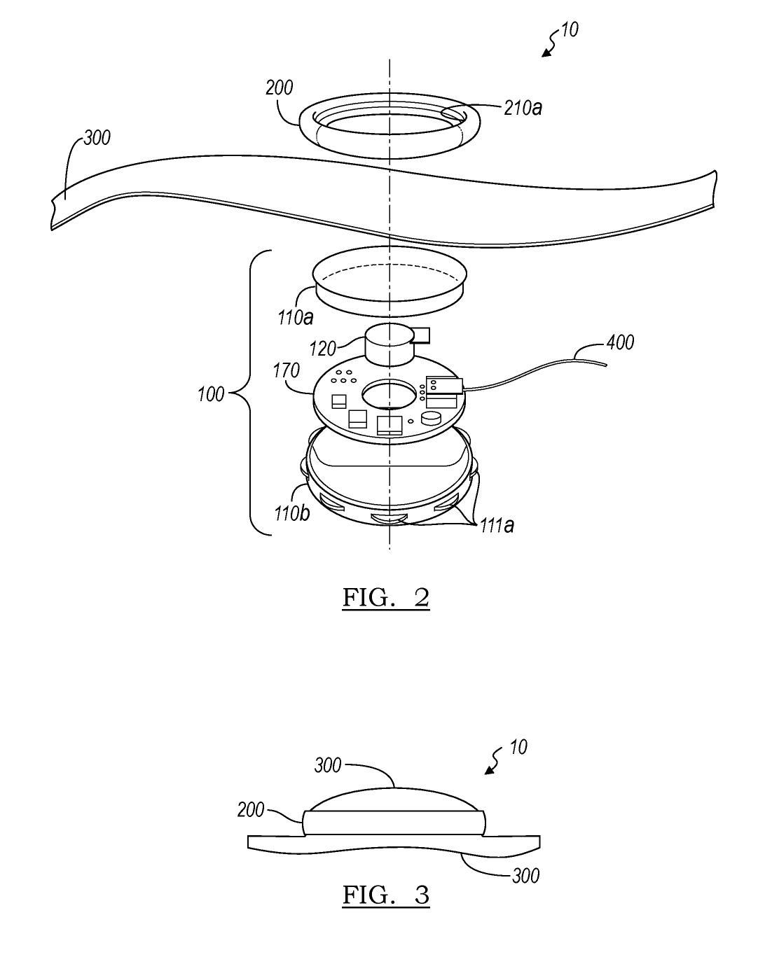

In a second embodiment, the retainer 200 includes a ring with a groove 210a which can (e.g., in the coupled mode) retain the ridges 111a protruding from the second housing part 110b. In a first variation of this embodiment (e.g., as shown in FIGS. 2-5), the system 10 includes an interconnect 400 with a conductive lead 410 extending from an interior component, through an aperture of the housing 110, to the housing exterior (e.g., analogous to the interconnect 400 described above regarding the first embodiment). In a second variation (e.g., as shown in FIG. 6), the interconnect 400 includes an electrical feedthrough 420 defined in the housing 110 and a substrate-embedded conductor 430 that contacts the feedthrough 420.

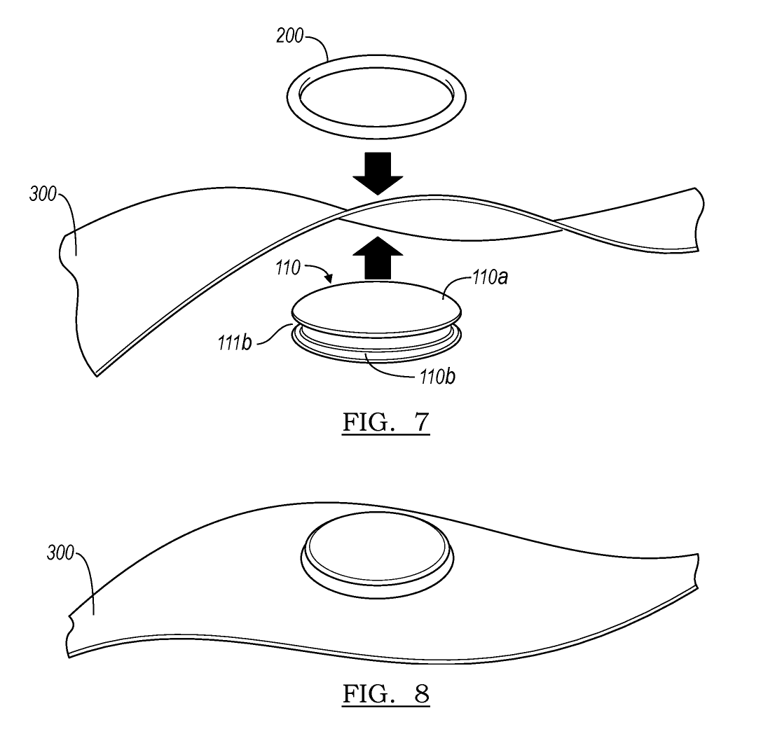

In a third embodiment (e.g., as shown in FIGS. 7-8), the retainer 200 includes a ring configured to be retained (e.g., in the coupled mode) within a groove 110b of the housing 110. In some variations, the device assembly 100 includes a battery and a wireless communication module 150 (e.g., and omits the interconnect 400). In other variations, the system 10 includes one or more interconnects 400 (e.g., as described above).

In some examples of this embodiment, the ring and housing 110 are both formed of an injected molded thermoplastic material that exhibits desirably low thermal expansion and contraction properties. In such variations, strength and stability of the snap-fit mechanism that may bind the retainer 200 to the housing 110 and bind the housing 110 and the retainer 200 to the attachment substrate 300, may be improved by forming the ring with an inner diameter equal to or slightly greater than an outer diameter of the housing 110 to ensure a proper snap fit. When the ring is subsequently heated to a malleable or near-malleable state, the ring may expand thermally until its inner diameter is just sufficient to permit snap-attaching the retainer 200 onto the annular groove 111b of the housing 110. As the retainer 200 cools ‘in place’ (e.g., cools while received in the annular groove 111b), with the attachment substrate 300 located between the housing 110 and retainer 200, the retainer 200 contracts thermally and its inner diameter may decrease relative to the outer diameter of annular ring 111b, thereby resulting in a tightening of the retainer 200 around the housing 110 and an increase of the strength of the binding of the attachment substrate 300 between the retainer 200 and the housing 110 (e.g., as shown in FIG. 8).

However, the system 10 can include any other suitable combination of coupling structures, interior components, and interconnects, and/or can include any other suitable elements in any suitable arrangement.

### 2. Method

The system 10 can be employed to perform one or more methods. For example, the method can include: attaching one or more device assemblies 100 to the attachment substrate 300, coupling the attachment substrate 300 to a user (e.g., the user wears a garment including the attachment substrate 300), and using the device assemblies 100 to provide information to the user (e.g., as described in U.S. patent application Ser. No. 15/452,207, titled “Providing Information to a User through Somatosensory Feedback”, U.S. patent application Ser. No. 15/661,934, titled “Method and System for Determining and Providing Sensory Experiences”, and/or U.S. patent application Ser. No. 15/696,997, titled “Method and System for Providing Adjunct Sensory Information to a User”, each of which is incorporated in its entirety by this reference). The method can optionally include (e.g., after providing information to the user): removing one or more device assemblies 100 from the attachment substrate 300, re-coupling all or some of the removed device assemblies 100 to the attachment substrate 300, and/or repeating use of the device assemblies 100 (e.g., in a different spatial arrangement) to provide information to the user. However, the method can additionally or alternatively include any other suitable elements performed in any other suitable manner.

Although omitted for conciseness, the preferred embodiments include every combination and permutation of the various system components and the various method processes. Furthermore, various processes of the preferred method can be embodied and/or implemented at least in part as a machine configured to receive a computer-readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processing subsystem, but any suitable dedicated hardware device or hardware/firmware combination device can additionally or alternatively execute the instructions.

The FIGURES illustrate the architecture, functionality and operation of possible implementations of systems, methods and computer program products according to preferred embodiments, example configurations, and variations thereof. In this regard, each block in the flowchart or block diagrams may represent a module, segment, step, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

We claim:

1. A system for tactile stimulation of a user wearing a garment, comprising:
a tactile stimulation assembly comprising a vibrational actuator and a processor electrically coupled to the vibrational actuator;
a housing surrounding the tactile stimulation assembly, the housing defining a first coupling structure; and
a retainer defining a second coupling structure;
the system operable in a coupled mode wherein:
the second coupling structure encircles the first coupling structure;
a region of a flexible material of the garment is retained between the first and second coupling structures by a compressive force cooperatively exerted on the region by the first and second coupling structures; and
the garment mechanically couples the housing to the user, wherein the housing transmits tactile stimulation from the vibrational actuator to the user.

2. The system of claim 1, wherein, in the coupled mode, the first coupling structure causes a circumferential tensile stress in the second coupling structure.

3. The system of claim 1, wherein:
the retainer comprises an inner surface defining an aperture, wherein the second coupling structure is arranged along the inner surface; and
in the coupled mode, a majority of the garment within a convex hull of the region is exposed through the aperture.

4. The system of claim 1, wherein, in the coupled mode, the system does not protrude through the garment.

5. The system of claim 1, further comprising a conductor electrically coupled to the processor, wherein, in the coupled mode, the conductor electrically couples the processor to an external device.

6. The system of claim 5, wherein the housing comprises a conductive feedthrough extending from an interior of the housing to an exterior of the housing, the conductor comprising the conductive feedthrough.

7. The system of claim 5, wherein, in the coupled mode, the conductor electrically couples the processor to the external device via a conductive lead of the garment.

8. The system of claim 1, further operable in an uncoupled mode wherein:
the garment is not retained between the housing and the retainer; and
the garment does not mechanically couple the housing to the user;
wherein the system is operable to repeatedly transition between the coupled and uncoupled modes.

9. The system of claim 1, wherein the housing fluidly isolates the tactile stimulation assembly from an ambient environment.

10. The system of claim 1, wherein the tactile stimulation assembly further comprises an audio sensor electrically coupled to the processor.

11. A system for sensory stimulation of a user wearing a garment, comprising:
a sensory stimulation assembly comprising a sensory output device and a processor electrically coupled to the sensory output device;
a housing comprising a first and second housing portion, the housing surrounding the tactile stimulation assembly, the housing defining a first coupling structure and an aperture;
a conductive lead electrically coupled to the processor, the conductive lead extending from the processor through the aperture; and
a retainer defining a second coupling structure;
the system operable in a coupled mode wherein:
a region of the garment is retained between the first and second coupling structures by a frictional force between the region and at least one of the first and second coupling structures;
the conductive lead electrically couples the processor to an external device; and
the garment couples the housing to the user.

12. The system of claim 11, wherein, in the coupled mode:
the second coupling structure encircles the first coupling structure; and
the first coupling structure causes a circumferential tensile stress in the second coupling structure.

13. The system of claim 11, wherein:
the retainer defines an aperture; and
in the coupled mode, a majority of the garment within a convex hull of the region is exposed through the aperture.

14. The system of claim 11, wherein, in the coupled mode, the system does not protrude through the garment.

15. The system of claim 11, wherein the housing and the conductive lead cooperatively isolate the sensory stimulation assembly from water of an ambient environment.

16. The system of claim 11, further operable in an uncoupled mode wherein:
the garment is not retained between the housing and the retainer; and
the garment does not mechanically couple the housing to the user;
wherein the system is operable to repeatedly transition between the coupled and uncoupled modes.

17. The system of claim 11, wherein the sensory stimulation assembly further comprises an environmental sensor electrically coupled to the processor.

18. The system of claim 17, wherein the environmental sensor comprises an audio sensor.

19. The system of claim 17, wherein the processor is configured to:
receive electrical power via the conductive lead;
receive an input signal from the environmental sensor; and
control the sensory output device based on the input signal.

20. The system of claim 11, wherein the processor is configured to:
receive a control signal via the conductive lead; and
control the sensory output device based on the control signal.

21. The system of claim 11, wherein:
the sensory output device comprises a vibratory actuator; and
the housing transmits tactile stimulation from the vibratory actuator to the user.
